(19) United States
(12) Patent Application Publication
(10) Pub. No.: US 2013/0312300 A1
(43) Pub. Date: Nov. 28, 2013

(54) REUSABLE AND ENERGY-SAVING LED SIGN BOARD

(71) Applicant: Myeong-Ho Lee, Gyeonggi-do (KR)

(72) Inventor: Myeong-Ho Lee, Gyeonggi-do (KR)

(21) Appl. No.: 13/985,997

(22) PCT Filed: Aug. 12, 2011
(86) PCT No.: PCT/KR2011/005940

§ 371 Date: Aug. 16, 2013

(30) Foreign Application Priority Data
Feb. 23, 2011 (KR) 10-2011-0015868

(51) Int. Cl. H05B 33/08; G09F 13/00

(52) U.S. Cl. CPC H05B 33/0863; G09F 13/005
USPC 40/541

(57) ABSTRACT

Disclosed herein is a reusable and energy-saving LED sign board. The LED sign board includes an LED array board (120) which is provided with a plurality of LEDs and is disposed in a frame (100), a front panel (130) which is provided on a front surface of the frame and includes an advertising design having a transmitting area (131) and a non-transmitting area (133), a memory unit (140) which stores LED activation information and LED operation information therein, and a control unit (150) which identifies activated LEDs of the LEDs, provided on the LED array board, based on the LED activation information and controls the operation of the activated LEDs based on the LED operation information. In the present invention, the LED activation information and the LED operation information can be created by user software which is installed in a computer of a user.

### TECHNICAL FIELD

The present invention relates, in general, to LED sign bards and, particularly, to a reusable and energy-saving LED sign board which can be easily reused merely by replacing an advertising design such as words, patterns, etc. with a new one. More particularly, the present invention relates to a user-oriented LED sign board which enables a user to use software provided along with the sign board and easily set or change the operation of LEDs in response to an advertising design.

### BACKGROUND ART

Recently, LEDs are used in interior or exterior advertisements or sign boards for the purpose of saving energy. LED sign boards are manufactured into a channel type sign board in which sidewalls enclose a circumferential outer edge of an advertising letter or figure. For example, in a sign board of FIG. 1 introduced in Korean Patent Laid-open Publication No. 10-2004-0086659, a plurality of LEDs are connected to each other by a wire (electric wire) in a reversed-M shaped channel sign board which is designated by reference numeral 200.

However, in the conventional sign board, it is neither easy to form the channel of the sign board nor to connect LEDs to each other. Furthermore, even the simple work of setting or changing operation of each LED such as color variation or flashing must completely depend on a skilled technician for installation of the sign board. Therefore, it is difficult to reuse such a conventional sign board. For instance, if it is required to change contents of an advertising design, another channel corresponding to changed contents must be manufactured, and LEDs must also be rearranged in the channel. Leaving aside the issue of difficulty in work, excessive costs and time are required.

### DISCLOSURE

### Technical Problem

Accordingly, the present invention has been made keeping in mind the above problems occurring in the prior art, and an object of the present invention is to provide a reusable LED sign board.

Another object of the present invention is to provide an LED sign board in which user software are provided along with the sign board so that the user can select whether each LED is activated or not and easily set a series of operation of the activated LEDs.

### Technical Solution

In order to accomplish the above objects, the present invention provides a reusable and energy-saving LED sign board having a frame, the LED sign board including: an LED array board comprising a plurality of LEDs, the LED array board being disposed in the frame; a front panel provided on a front surface of the frame, the front panel having an advertising design comprising a transmitting area and a non-transmitting area; a memory unit storing an LED activation information and an LED operation information therein; and a control unit identifying activated LEDs of the LEDs, provided on the LED array board, based on the LED activation information, the control unit controlling operation of the activated LEDs based on the LED operation information. The LED operation information may comprise information that defines time-varying light emitting operation of the activated LEDs with respect to color variation and flashing variation.

The LED activation information and the LED operation information may be set by user software installed in a computer of a user. The LED activation information and the LED operation information that are created by the user software may be stored in a portable storage device. The portable storage device may be inserted into the memory unit. The user software may have at least one preset. The preset is predefined LED operation information.

The reusable and energy-saving LED sign board may further include a partition removably provided on the LED array board in a column direction of the LED array board. The front panel may include: a sheet on which an advertising design is provided; and a transparent panel disposed on a front surface of the sheet.

### Advantageous Effects

In a reusable and energy-saving LED sign board according to the present invention, a sign board can be easily reused in such a simple way that a user replaces a front panel with a new one and re-selects and resets activated LEDs.

Furthermore, it is required to activate only LEDs that correspond to a transmitting area of an advertising design, thus reducing power consumption.

In addition, the operation of the activated LEDs such as color variation and flashing variation can be easily set and modified. Therefore, the present invention can meet various requirements of users.

### DESCRIPTION OF DRAWINGS

FIG. 1 is a view showing FIG. 5 of a prior patent document.

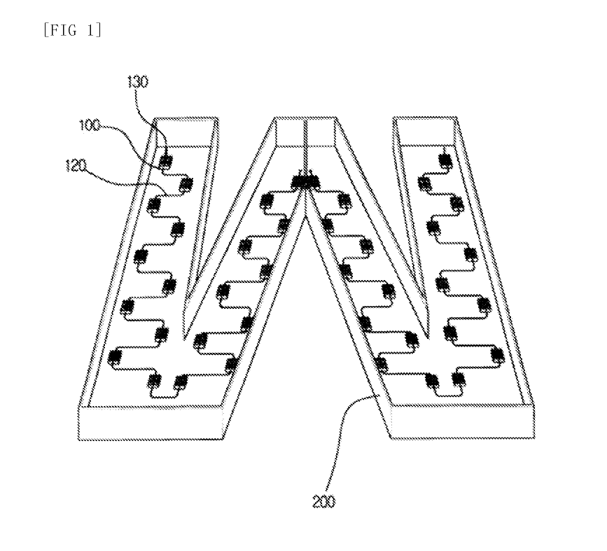

FIG. 2 is a perspective view illustrating a sign board (100), according to an embodiment of the present invention.

FIG. 3 is an exploded perspective view of the sign board (100) of FIG. 2.

FIG. 4 is a plan view of an LED array board (120) of FIG. 3.

FIG. 5 is a view illustrating the LED array board (120) of FIG. 3 that is installed in a frame (110).

FIG. 6 is a plan view illustrating a front panel (130) of FIG. 3.

FIG. 7 is a view showing the sign board (100) of the present invention and a software screen provided to a user.

FIG. 8 is a view showing a partition (160) installed on the LED array board (120) of FIG. 3.

FIG. 9 is a view showing a modification of the front panel (130) according to the present invention.

### BEST MODE

The above and other objects, features and advantages of the present invention will be more clearly understood from the following detailed description taken in conjunction with the accompanying drawings. If in the specification, detailed descriptions of well-known functions or configurations would unnecessarily obfuscate the gist of the present invention, the detailed descriptions will be omitted.

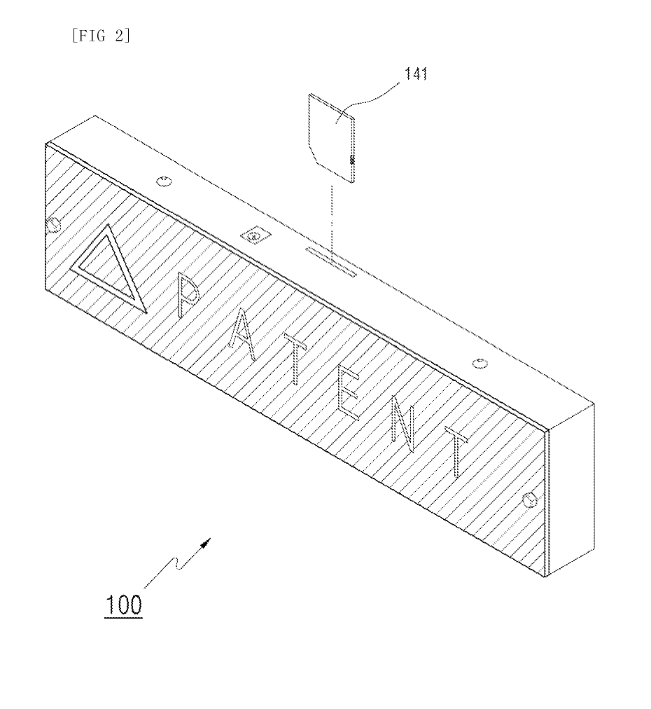

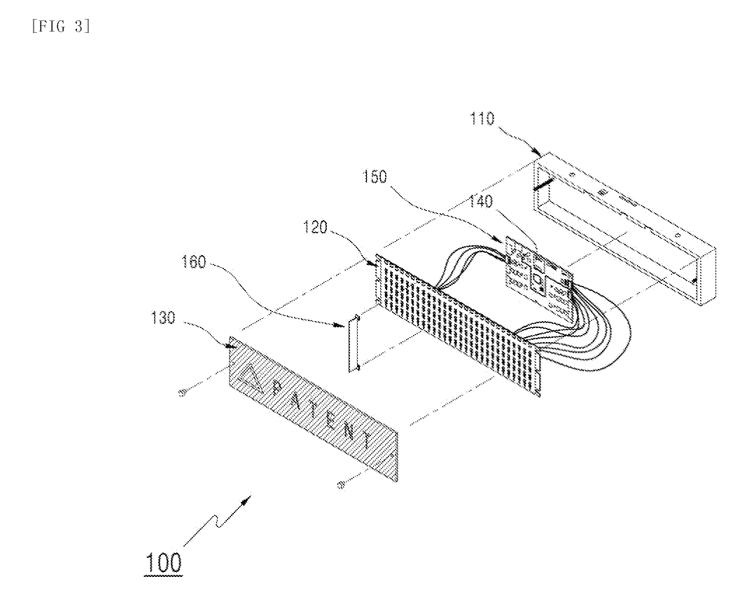

As shown in FIG. 2, an LED sign board (hereinafter, referred to as a ‘sign board’) according to an embodiment of the present invention is designated by reference numeral ‘100’. Referring to the exploded perspective view of FIG. 3, the sign board 100 of the present invention includes a frame 110, an LED array board 120, a front panel 130, a memory unit 140 and a control unit 150. An element designated by reference numeral 160 will be explained later herein.

In detail, the frame 110 has a rectangular shape (of course, the frame 110 may not have a rectangular shape) and functions to support and contain the LED array board, the front panel, the memory unit and the control unit therein.

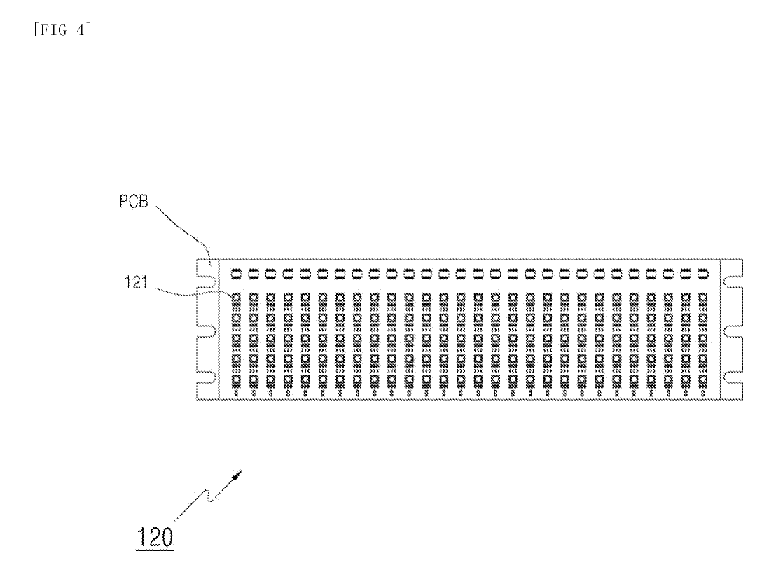

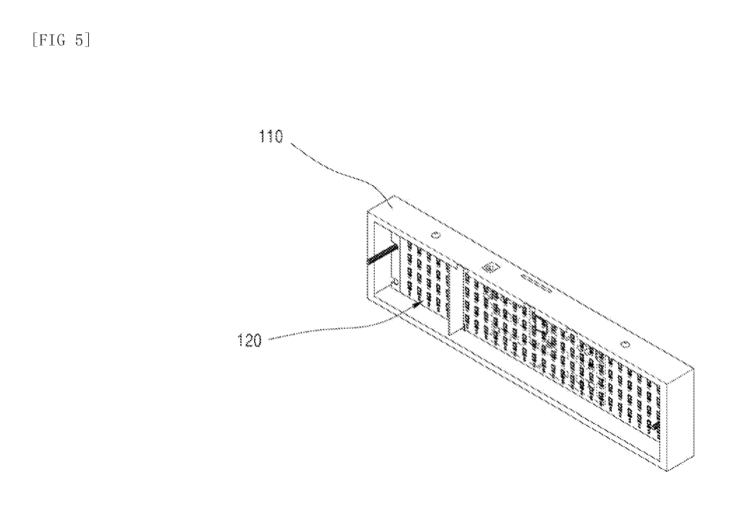

Referring to FIG. 4, the LED array board 120 is a PCB on which a plurality of LEDs 121 are provided in an arrangement of N×M and is disposed in the frame 110 (refer to FIG. 5). In the drawings, although the LEDs 121 are illustrated as being provided in an arrangement of 5×28, the present invention is not limited to this size. The LEDs 121 are package type LEDs or chip type LEDs which can emit various colors with a combination of RGB (red, green and blue).

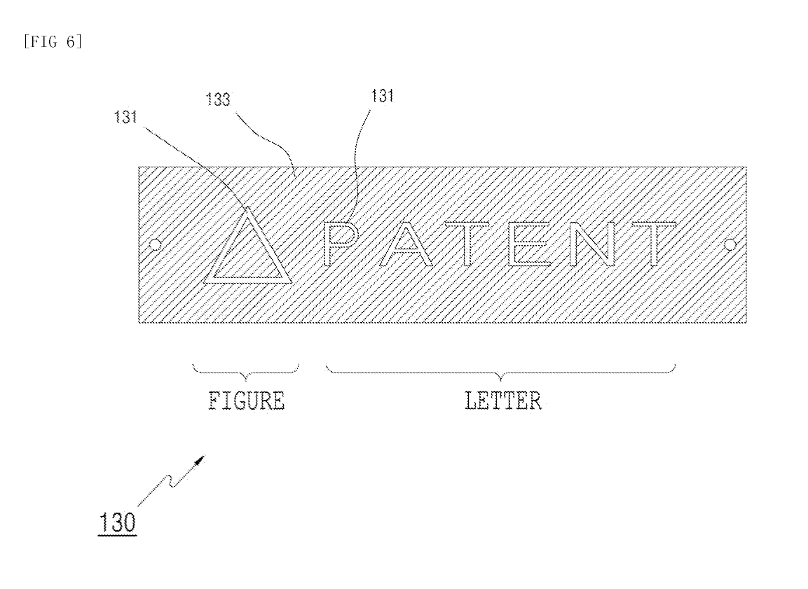

FIG. 6 is a plan view of the front panel 130. The front panel 130 is provided on a front surface of the frame 110. The front panel 130 includes an advertising design which is formed by a combination of a transmitting area 131 through which light emitted from the LEDs 121 passes and a non-transmitting area 133 through which light cannot pass. The advertising design may be a figure and/or letters. For example, as shown in the drawings, the advertising design may include a figure of a triangle and the letter ‘PATENT’.

The memory unit 140 stores information for controlling the operation of the LED array board 120. Information stored in the memory unit 140 is largely classified into LED activation information and LED operation information. As shown in FIG. 2, the memory unit 140 is configured in such a way that it receives a portable storage device 141, for example, a SD card memory, a CF card memory, a USB memory, etc. and reads storage information from the portable storage device 141.

The control unit 150 is provided in the frame 110 and controls the LED array board 120 in response to the LED activation information and the LED operation information of the memory unit 140. In more detail, the LED activation information is information about whether each of the LEDs 121 provided on the LED array board 120 is activated. According to an aspect of the present invention, only LEDs 121 that correspond to the transmitting area of the advertising design may be selectively activated. In this case, LEDs that correspond to the non-transmitting area 133 of the advertising design are not activated. This provides a power-saving effect. The LED operation information is information about the operation of the activated LEDs, for example, information defining a series of operations related to variation in color and variation in the flashing of the LEDs. The control unit 150 of the present invention controls the operation of the activated LEDs based on the LED operation information.

Meanwhile, according to an aspect of the present invention, user software for setting the LED activation information and the LED operation information is provided. The user software is a program which enables the user to simulate the LED array board 110. When the sign board is provided to the user, the user software can be provided by means of a storage medium such as a CD (compact disk) or a web server.

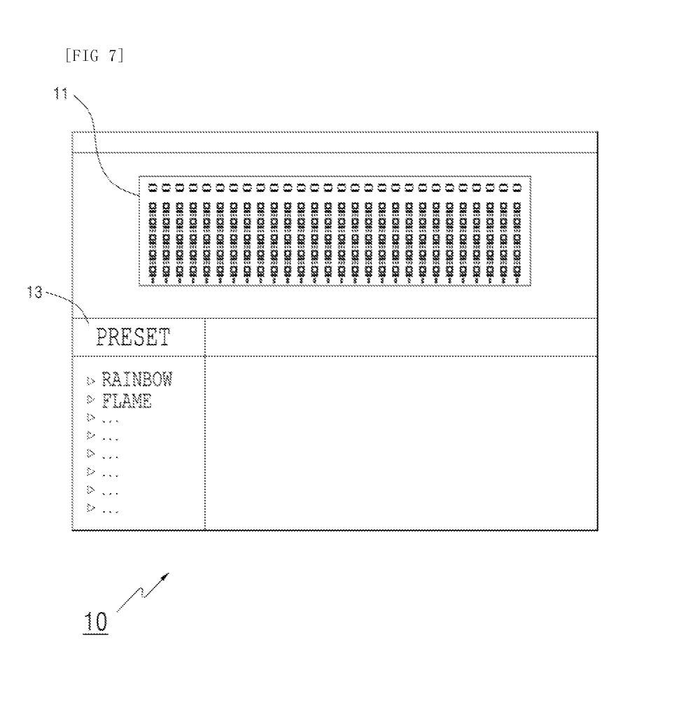

FIG. 7 is a view showing a screen output by the user software installed in a computer of the user. In this embodiment, the user software is illustrated as being embodied by a graphical interface. The screen 10 shown in FIG. 7 is a computer screen (monitor) which displays a pseudo or virtual array board 11 of the LED array board 120. Therefore, the user can use the screen 10 and easily identify and select LEDs that must be activated. Furthermore, the user can intuitively or easily set information about variation in color or flashing light of each of the activated LEDs.

For reference, it is not easy for the user to individually set all operations of the activated LEDs. Given this, the user software according to the present invention preferably has at least one preset 13. The preset 13 refers to LED operation information in which time-varying light emitting operation with regard to flashing variation of the selected activated LEDs including color variation is previously input. One selected from among a plurality of presets 13 is used as the LED operation information. Here, it can be understood that the time-varying light emitting operation is a series of patterns which are transmitted to users through the transmitting area of the advertising design. For instance, there may be patterns which are moved to the left and the right with variation in color, patterns which are moved upwards or downwards to depict a flame blazing, and so on. These patterns are known in this art; therefore, further explanation is deemed unnecessary.

As stated above, the LED activation information and the LED operation information which are set by the user software are stored in the portable storage device 141 which is connected to the computer of the user. Subsequently, when the portable storage device 141 is inserted into the memory unit 140, the control unit 150 reads the LED activation information and the LED operation information from the portable storage device 141 and controls the LED array board 120.

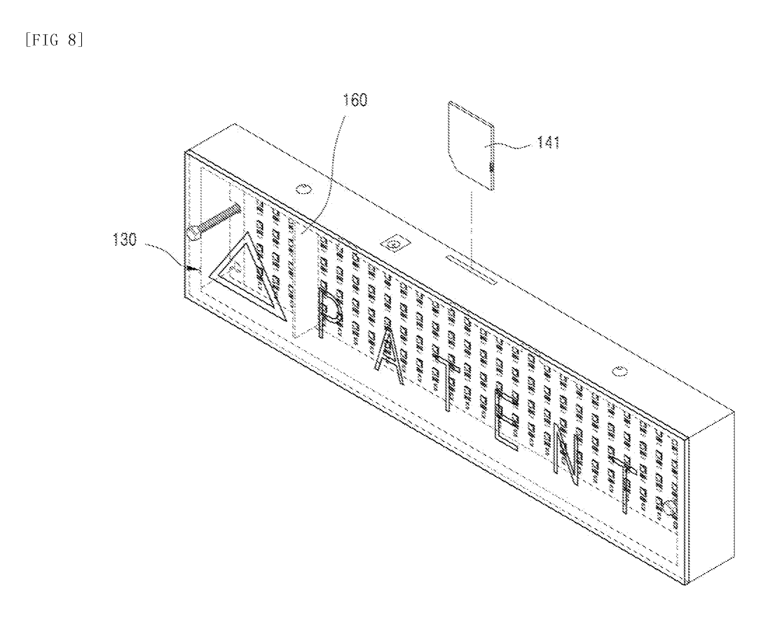

Referring to FIGS. 3 and 8, the sign board 100 of the present invention may further include a partition 160 which is installed on the LED array board 120 in a column direction. In FIG. 8, the front panel 130 is expressed to be transparent for the sake of explanation. The partition 160 partitions the LED array board 120 into two parts and functions to isolate lights emitted from the LEDs, which are provided on the left and right partitioned areas of the LED array board 120, from each other. For example, as described above, if the advertising design includes a figure and letters, LEDs that pertain to the figure are partitioned from LEDS that correspond to the letters by the partition 160. In this case, LED operation information may be set differently depending on the partitioned areas (a figure area and a letter area).

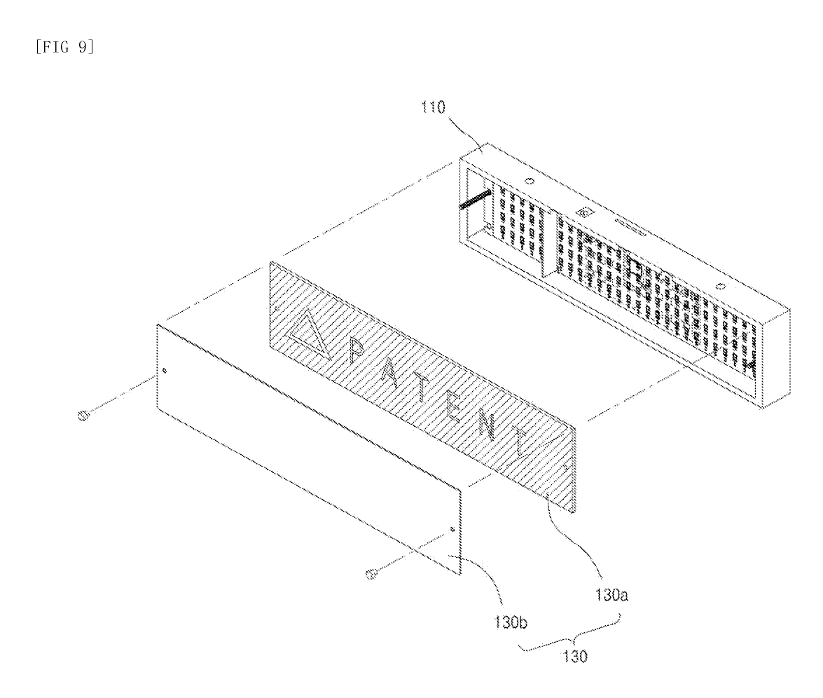

Although the preferred embodiment of the present invention has been disclosed for illustrative purposes, the present invention is not limited to the constructions and operation illustrated in the embodiment. For instance, the front panel 130 may be embodied by a method illustrated in FIG. 9. Reference numeral 130a denotes a sheet on which an advertising design is formed, and reference numeral 130b denotes a transparent panel which is disposed on a front surface of the sheet 130a. The sheet 130a is advantageous in that a transmitting area and a non-transmitting area can be set, as needed, by printing. As such, those skilled in the art will appreciate that various modifications, additions and substitutions are possible, without departing from the scope and spirit of the invention as disclosed in the accompanying claims. Therefore, these modifications, additions and substitutions must also be regarded as falling within the bounds of the present invention.

### INDUSTRIAL APPLICABILITY

As described above, the present invention can be applied to an advertisement sign board. The sign board according to the present invention is configured such that a user uses software and is able to easily set and change the operation of each LED, thus making operation more convenient for the user.

1. A reusable and energy-saving LED sign board having a frame, the LED sign board comprising:
an LED array board comprising a plurality of LEDs, the LED array board being disposed in the frame;
a front panel provided on a front surface of the frame, the front panel having an advertising design comprising a transmitting area and a non-transmitting area;
a memory unit storing an LED activation information and an LED operation information therein; and
a control unit identifying activated LEDs of the LEDs, provided on the LED array board, based on the LED activation information, the control unit controlling operation of the activated LEDs based on the LED operation information.

2. The reusable and energy-saving LED sign board of claim 1, wherein the LED activation information and the LED operation information are set by user software installed in a computer of a user.

3. The reusable and energy-saving LED sign board of claim 2, wherein the LED activation information and the LED operation information that are created by the user software are stored in a portable storage device,
wherein the portable storage device is inserted into the memory unit and is read by the memory unit.

4. The reusable and energy-saving LED sign board of claim 1, wherein the activated LEDs comprise LEDs of the LED array board that correspond to the transmitting area of the advertising design.

5. The reusable and energy-saving LED sign board of claim 2, wherein the LED operation information comprises information that defines time-varying light emitting operation of the activated LEDs with respect to color variation and flashing variation.

6. The reusable and energy-saving LED sign board of claim 5, wherein the user software has at least one preset,
wherein the preset comprises predefined LED operation information.

7. The reusable and energy-saving LED sign board of claim 1, further comprising
a partition removably provided on the LED array board in a column direction of the LED array board.

8. The reusable and energy-saving LED sign board of claim 1, wherein the front panel comprises: a sheet on which an advertising design is provided; and a transparent panel disposed on a front surface of the sheet.

9. The reusable and energy-saving LED sign board of claim 3, wherein the LED operation information comprises information that defines time-varying light emitting operation of the activated LEDs with respect to color variation and flashing variation.
